(19) United States
(12) Patent Application Publication
(10) Pub. No.: US 2024/0059362 A1
(43) Pub. Date: Feb. 22, 2024

(54) ADJUSTABLE MODULAR SUPPORTING OF WHEELS OF TRACKED VEHICLE

(71) Applicant: Howe & Howe Inc., Waterboro, ME (US)

(72) Inventors: Forrest Joel Tripp, East Waterboro, ME (US); Anthony Victor Castro, Cape Elizabeth, ME (US)

(21) Appl. No.: 18/451,994

(22) Filed: Aug. 18, 2023

Related U.S. Application Data
(60) Provisional application No. 63/399,094, filed on Aug. 18, 2022.

(51) Int. Cl. B62D 55/15; B62D 55/30

(52) U.S. Cl. CPC B62D 55/15; B62D 55/30

(57) ABSTRACT

A modular apparatus is disclosed in which wheel assemblies of a tracked vehicle can be added, removed, located, and/or relocated over a wide range of adjustments. The apparatus includes a rail attached to the tracked vehicle. Modular wheel assemblies can be attached to the rail at variable locations.

### BACKGROUND

### Field of the Invention

This disclosure relates generally to tracked vehicles, and more particularly to supporting tracks of tracked vehicles in a modular, adjustable manner.

### Description of Related Art

Known tracked vehicles, such as tanks, recreational vehicles, robotic vehicles, and the like have wheels on each side of the vehicle. A track on each side travels in a loop formed by the outermost extents of the wheels on that side. One of the wheels on each side is typically a drive sprocket, which is coupled to a motor or engine, e.g., directly or via a transmission. Other wheels are typically passive, providing support for the track and turning as the track travels around in its loop.

### SUMMARY

Unfortunately, the above-described tracked vehicles have fixed-wheel arrangements that do not allow for adjustment. We have recognized, however, that it may sometimes be desirable to adjust the positions, types, and/or number of wheels used by tracked vehicles, such as to accommodate different loads, handling characteristics, speeds, and other factors. There is therefore a need for a more adjustable wheel arrangement for tracked vehicles.

The above need is addressed at least in part by an improved technique that provides a modular apparatus in which wheel assemblies of a tracked vehicle can be added, removed, located, and/or relocated over a range of adjustments. The apparatus includes a rail attached to the tracked vehicle and modular wheel assemblies that can be attached to the rail at variable locations. Advantageously, the modular apparatus enables the tracked vehicle to be configured in a wide variety of ways, for addressing a wide range of preferences and requirements.

In some examples, orientations of the wheel assemblies may be adjusted (e.g., to face forward or backward). In addition, different numbers and/or types of modular wheel assemblies may be attached to the rail. For example, more or heavier-duty wheel assemblies may be attached for carrying higher loads, and fewer or lighter-duty wheel assemblies may be attached for carrying lighter loads.

Certain embodiments are directed to an apparatus for supporting wheels of a tracked vehicle. The apparatus includes a rail that extends lengthwise along a side of the vehicle and a plurality of wheel assemblies attached to the rail at a set of user-selected locations along the rail. The wheel assemblies are constructed and arranged to guide a track in a loop around the wheel assemblies on the side of the vehicle.

In some examples, the rail is an indexed rail that defines discrete locations at which the plurality of wheel assembles can be attached.

In some examples, the indexed rail includes a plurality of equally-spaced features that define the discrete locations.

In some examples, each wheel assembly of the plurality of wheel assemblies attaches to the rail via at least two of the equally-spaced features.

In some examples, the rail includes first and second spaced-apart rail segments that run parallel to each other and have equally-spaced features that are transversely aligned.

In some examples, the equally-spaced features include concave regions constructed and arranged to receive convex features of the wheel assemblies.

In some examples, the rail is a lower rail constructed and arranged to attach to wheel assemblies that support the track from above, and the apparatus further comprises an upper rail constructed and arranged to attach to a wheel assembly that supports the track from below.

In some examples, the wheel assembly that supports the track from below includes a track tensioner and the wheel assembly that supports the track from below is constructed and arranged to attach to the second rail at multiple locations for establishing respective degrees of track tension.

Other embodiments are directed to a tracked vehicle. The tracked vehicle includes a vehicle hull, a first rail that extends lengthwise along a first side of the vehicle hull, and a second rail that extends lengthwise along a second side of the vehicle hull. The tracked vehicle further includes a first plurality of wheel assemblies attached to the first rail at a set of user-selected locations along the first rail, the first plurality of wheel assemblies constructed and arranged to guide a first track in a loop around the first plurality of wheel assemblies. The tracked vehicle still further includes a second plurality of wheel assemblies attached to the second rail at a set of user-selected locations along the second rail, the second plurality of wheel assemblies constructed and arranged to guide a second track in a loop around the second plurality of wheel assemblies.

In some examples, the first rail is constructed and arranged to support the first track from above, the second rail is constructed and arranged to support the second track from above. The tracked vehicle further includes a first upper rail that extends lengthwise along the first side of the vehicle hull, the first upper rail configured to support the first track from below, and a second upper rail that extends lengthwise along the second side of the vehicle hull, the second upper rail configured to support the second track from below.

In some examples, each of the first rail, second rail, first upper rail, and second upper rail includes a respective pair of spaced-apart rail segments.

In some examples, the first rail and the first upper rail are parts of a single weldment that attaches to the first side of the vehicle hull, and the second rail and the second upper rail are parts of a single weldment that attaches to the second side of the vehicle hull.

Further embodiments are directed to a method of configuring a tracked vehicle. The method includes providing a rail that extends lengthwise along a side of the tracked vehicle and selecting a plurality of wheel assemblies for attaching to the rail. The method further includes selecting a set of locations along the rail at which to attach the plurality of wheel assemblies and attaching the plurality of wheel assemblies at the selected locations.

In some examples, the method further includes moving at least one of the plurality of wheel assemblies from an initial location along the rail to a new location along the rail.

In some examples, selecting the plurality of wheel assemblies for attaching to the rail includes selecting between a first wheel assembly having suspension and a second wheel assembly not having suspension.

In some examples, a particular wheel assembly of the plurality of wheel assemblies is configured to attach to the rail in both a forward-facing direction and a reverse-facing direction, and the method further includes selecting one of the forward-facing direction or the reverse-facing direction when attaching the particular wheel assembly to the rail.

In some examples, the rail is a lower rail, the tracked vehicle includes a track that extends around the plurality of wheel assemblies, and the method further includes: providing an upper rail that extends lengthwise along the side of the tracked vehicle above the lower rail; providing a tensioner wheel assembly for attaching to the upper rail; and selecting a location along the upper rail at which to attach the tensioner wheel assembly for establishing a desired tension of the track.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views. The drawings are not necessarily to scale, emphasis instead being placed upon illustrating the principles of various embodiments.

FIG. 1 is a front plan view of an example tracked vehicle with which embodiments of the improved technique can be practiced.

FIGS. 2a and 2b are front plan and upper-left isometric views of an example suspension carrier of FIG. 1.

FIGS. 3a and 3b are perspective views of example wheel assemblies attached to an example rail of the suspension carrier of FIGS. 2a, and 2b.

FIGS. 4a and 4b are perspective views of an example wheel assembly.

FIGS. 5a, 5b, and 5c are front views of three respective styles of wheel assemblies that can be used in various embodiments.

FIGS. 6a and 6b are top-left and bottom-left isometric views of an example weldment that may be used in certain embodiments.

FIG. 7 is an example method of configuring a tracked vehicle in accordance with certain embodiments.

### DETAILED DESCRIPTION

Embodiments of the improved technique will now be described. One should appreciate that such embodiments are provided by way of example to illustrate certain features and principles but are not intended to be limiting.

An improved technique provides a modular apparatus in which wheel assemblies of a tracked vehicle can be added, removed, located, and/or relocated over a wide range of adjustments. The apparatus includes a rail attached to the tracked vehicle. Modular wheel assemblies may be attached to the rail at variable locations.

In some examples, the orientations of the wheel assemblies may be adjusted (e.g., to face forward or backward).

In some examples, different numbers of modular wheel assemblies may be attached to the rail. For example, more wheel assemblies may be attached for carrying higher loads, and fewer wheel assemblies may be attached for carrying lighter loads.

In some examples, the rail is provided as indexed rail to which wheel assemblies may be attached at defined locations along the rail.

In some examples, the indexed rail has semicircular channels or slots for receiving the wheel assemblies in multiple locations. For example, a wheel assembly may include a pair of cylindrical members (e.g., rods) configured to engage a corresponding pair of semicircular channels (e.g., slots) of the indexed rail.

In some examples, one or more of the wheel assemblies has a fixed design.

In some examples, one or more of the wheel assemblies has an articulating design. The articulating design may include suspension components, such as a spring, cushion, shock absorber, or the like.

In some examples, the above-described rail is a first rail for supporting wheels at a bottom portion of the track, and the platform further includes a second rail for supporting wheels at a top portion of the track. For example, a track tensioner may be attached to the second rail at variable positions as desired. The position of the track tension may be adjusted after a change in wheel assemblies, for example. For instance, the track tensioner may be moved along the second rail in a manner similar to the way the wheel assemblies may be moved along the first rail.

In some examples, the first rail and the second rail are attached together.

In some examples, the first rail includes two spaced-apart first-rail segments. In some examples, the wheel assemblies are attached to the rail via respective fasteners that pass between the two spaced-apart first-rail segments.

In some examples, the second rail includes two spaced-apart second-rail segments. In some examples, the tensioner is attached to the second rail via a fastener that passes between the two spaced-apart second-rail segments.

In some examples, placement and adjustments in locations of the wheel assemblies and/or tensioner are performed manually. In other examples, placement and adjustments of the wheel assemblies and/or tensioner are performed automatically, such as by a motorized system that moves the wheel assemblies and/or tensioner along the respective rails in response to an electronic controller, which may be operated by a user or machine.

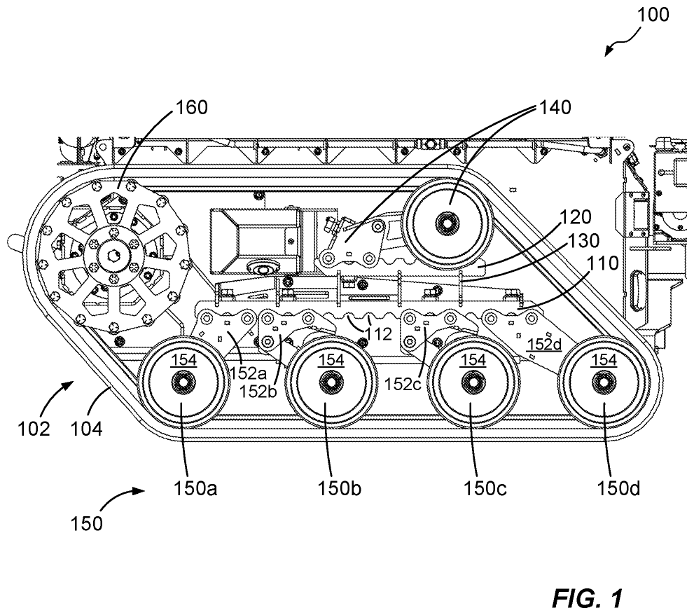

FIG. 1 is a side view of a tracked vehicle 100, showing a portion of a suspension carrier 102 on one side of the vehicle 100. A similar suspension carrier 102 (not shown) may be provided on the other side of the vehicle 100, which may be a mirror-image of the one shown.

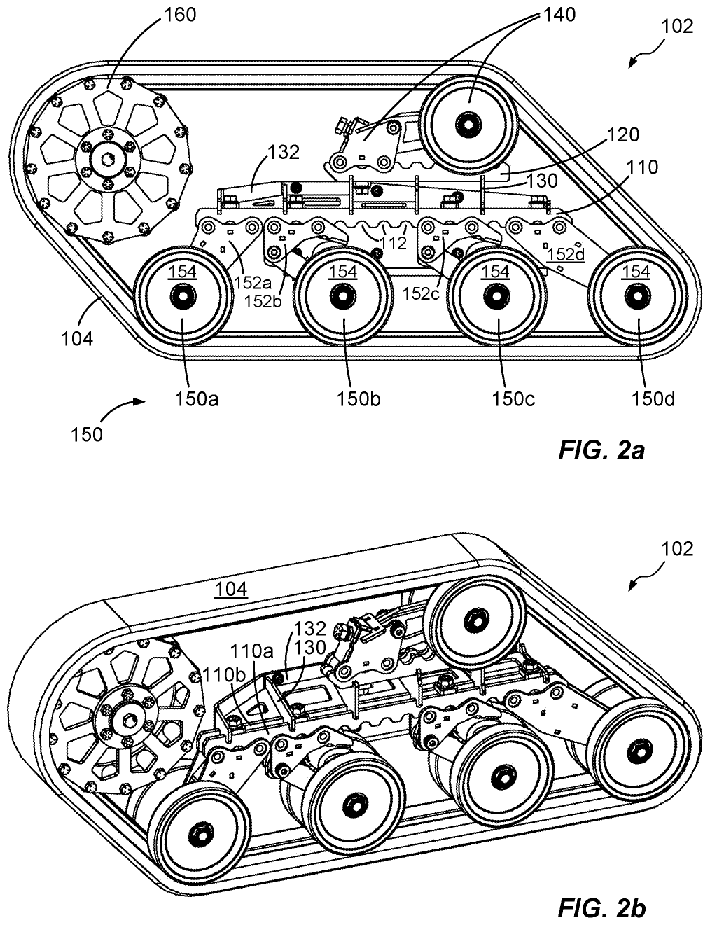

As further shown in FIG. 1, as well as in FIGS. 2a and 2b, the suspension carrier 102 includes a rail 110 that extends lengthwise along at least a portion of a length of the suspension carrier 102. The rail 110 may be fixedly attached to a frame (not shown) of the suspension carrier 102 or to a hull or body of the vehicle 100, such that the rail 110 is stationary with respect to the suspension carrier 102 and with respect to the vehicle hull.

Multiple wheel assemblies 150 (e.g., 150a, 150b, 150c, and 150d) may be attached to the rail 110 using brackets 152 (e.g., 152a, 152b, 152c and 152d), which may be considered herein to be parts of the respective wheel assemblies 150. The wheel assemblies 150 are configured to define a bottom extent of the suspension carrier 102 and include respective wheels 154 configured to roll. A track 104 extends around the wheels 154 and is driven around a loop-shaped path by a drive sprocket 160.

In some examples, the rail 110 is indexed to receive the wheel assemblies 150 at discrete locations. For example, the rail 110 may have equally-spaced features, such as channels 112 (e.g., concave or semicircular slots or indentations) formed therein for establishing attachment points for the wheel assemblies 150. Indexing is not required, however, and some embodiments may allow for continuous positioning along the rail 110, e.g., via clamps or other attachment hardware.

The wheel assemblies 150 may be varied in number, location, and orientation. For example, wheel assemblies may be forward-facing, as in assembly 150a, or they may be backward-facing, as in assemblies 150b, 150c, and 150d. In addition, wheel assemblies 150 may be moved forward or back along the rail 110, e.g., to different indexed positions. Some wheel assemblies, such as 150b or 150c, may be removed, e.g., for lighter loads, and one or more additional wheel assemblies may be added, e.g., for heavier loads.

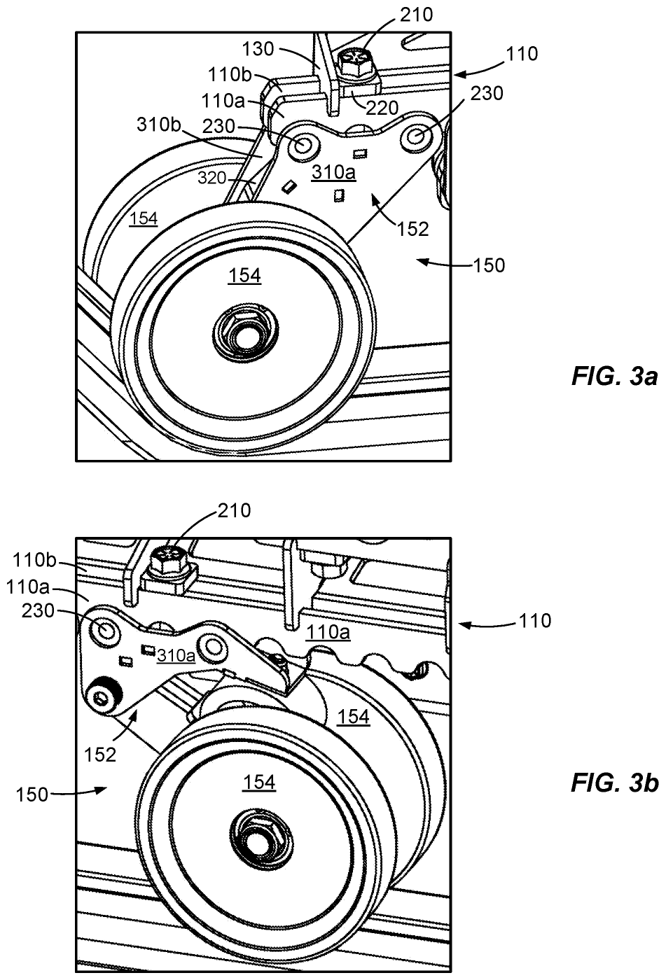

In the illustrated example, each wheel assembly includes two wheels 154, with one wheel placed on one side of the bracket 152 and the other wheel placed on the other side of the same bracket 152 (see FIGS. 3a and 3b).

Brackets 152 may connect wheel assemblies 150 to the rail 110 using bolts 210. In such cases, a manual procedure may be used to attach wheel assemblies 150 to the rail 110. Automated arrangements are also contemplated. For example, wheel assemblies 150 may be connected to cables and/or conveyors which move them forward and/or back, with motorized bolts or other fasteners applied to tighten the wheel assemblies 150 at desired locations. Such cables, conveyors, and/or motorized bolts may be actuated by electronic control circuitry (not shown), which may be operated by a human user or by machine.

Returning to FIGS. 2a and 2b, the above-described rail 110 may be referred to as a “lower rail,” and the suspension carrier 102 may further include an upper rail 120, which may also have a fixed position relative to the suspension carrier 102 (e.g., it is fixedly attached to the suspension carrier 100 or to the hull of the vehicle). In the illustrated embodiment, the upper rail 120 is attached to the lower rail 110 by multiple joiners 130. The upper rail 120 provides adjustable attachment points for wheel assemblies 150 that may be provided at the top of the suspension carrier 100. A special case of such upper wheel assemblies is a tensioner 140, which may be used to tension the track 104 and may be moved forward and/or back along the second rail 120 for this purpose. In an example, the upper rail 120 is similar in construction to the lower rail 110 (except that it is upside-down), and adapters 152 of wheel assemblies 150 attach to the upper rail 120 the same way that adapters 152 attach to the lower rail 110. This is not required, though, as the rails may alternatively have different construction. In the manner shown, the lower rail 110 supports the track 104 from above and the upper rail 120 supports the track 104 from below.

In some examples, a single rail (now shown) is provided for both the lower rail 110 and the upper rail 120. For example, a single rail may be bent in a loop or partial loop. Preferably, however, individual rails are provided. In an example, the above-described joiners 130 further attach both rails 110 and 120 to a mounting bracket 132, which may attach to the hull of the vehicle 100.

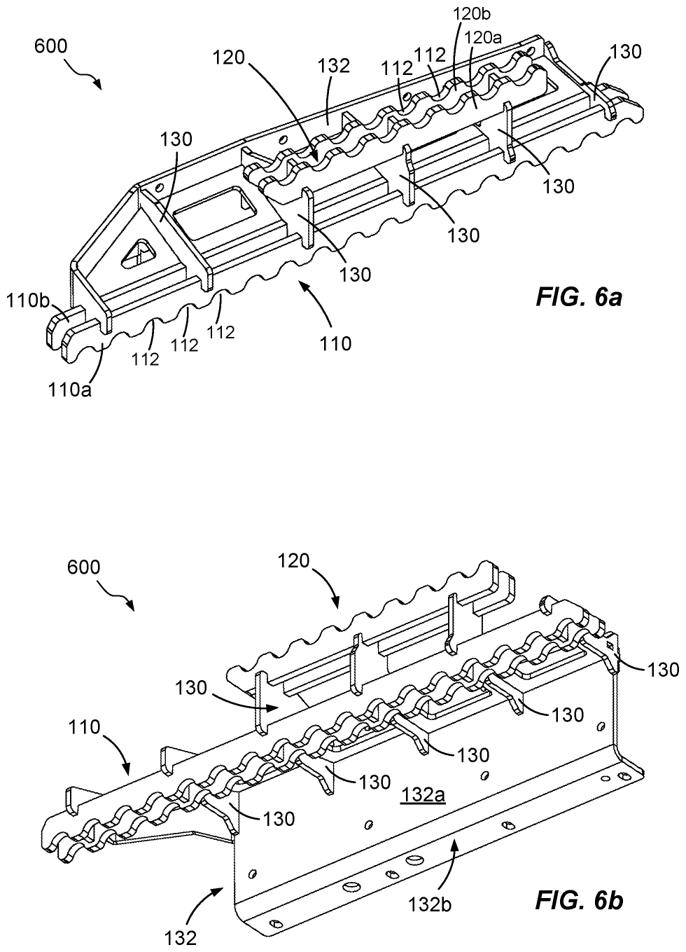

FIGS. 3a and 3b show an example attachment of an adapter 152 of a wheel assembly 150 to the rail 110. Here, it is seen that the rail 110 includes a first rail segment 110a and a second rail segment 110b, which are spaced apart and parallel. Both rail segments 110a and 110b include features 112 (e.g., concave indentations), and these features are aligned transversely. In an example, the joiners 130 still further perform the function of maintaining proper spacing between the rail segments 110a and 110b. It is noted that, like the rail 110, the rail 120 may also include first and second rail segments 210a and 210b (see rail segments 210a and 210b in FIGS. 6a and 6b).

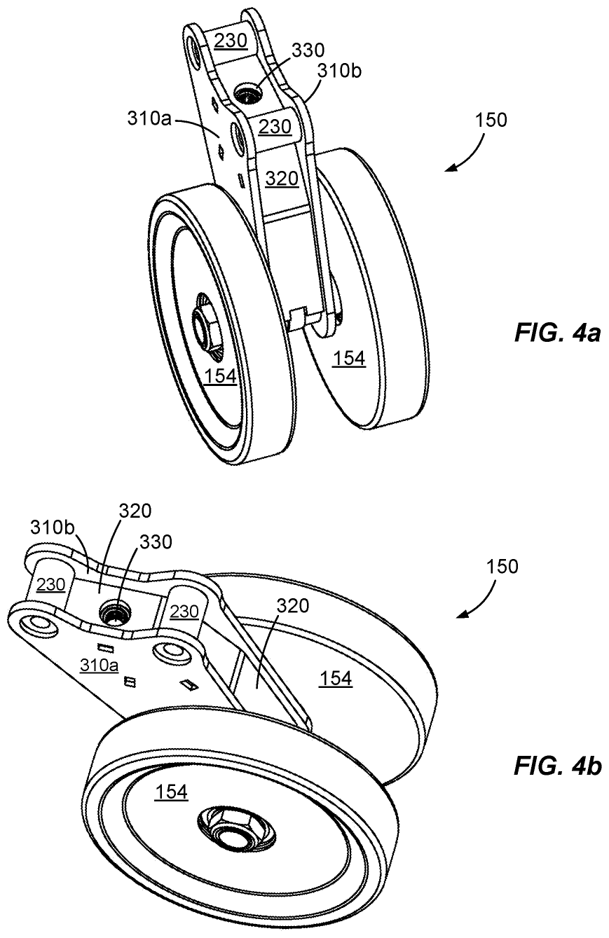

As further shown in FIGS. 3a and 3b, the adapter 152 includes a first adapter plate 310a and a second adapter plate 310b. The two adapter plates may be joined together by a bridge piece 320. In an example, the bridge piece 320 includes a threaded hole 330 (see FIGS. 4a and 4b) for receiving a bolt 210.

A pair of cylindrical rods 230 extend between the first adapter plate 310a and the second adapter plate 310b. The cylindrical rods 230 are configured to engage respective concave regions 112 in the rails, and the bolt 210 is configured to pass from above the rail, between the rail segments, and into the threaded hole 330 in the bridge piece 320. A washer 220 may be used when attaching the bolt 210. In this manner, the wheel assembly 150 is held firmly against the rail. In some examples, greater than two cylindrical rods 230 may extend between the first adapter plate 310a and the second adapter plate 310b, for engaging greater than two concave regions 112, e.g., for providing additional strength.

FIGS. 4a and 4b provide respective views of an example wheel assembly 150. In an example, adapter plate 310a, adapter plate 310b, bridge piece 320, and cylindrical rods 230 are formed together as a unitary welded structure.

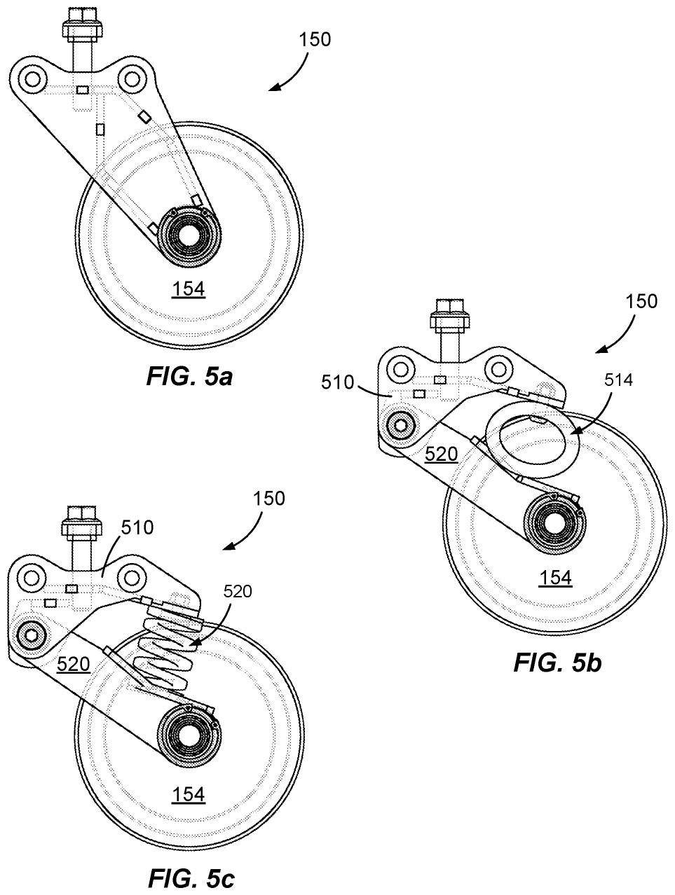

FIGS. 5a, 5b, and 5c show three different examples of wheel assemblies 150, which are suitable for use in the embodiments above. The FIG. 5a assembly is fixed and provides no suspension. The FIG. 5b assembly has an articulating design, which includes an upper bracket 510, a lower bracket 512, and a cushion piece 514, such as a rubber or elastomeric disk or bladder, which provides suspension. The lower bracket 512 is rotatably coupled to the upper bracket 510, and the cushion piece 514 absorbs shock while maintaining a desired angle between the upper and lower brackets. The FIG. 5c arrangement is similar to the FIG. 5b arrangement but uses a spring 520 rather than a cushion for providing suspension. In some examples, a separate shock absorber (not shown) may be used in connection with the spring 520. For example, a shock absorber may be mounted concentrically with the spring 520. One should appreciate that the above examples of wheel assemblies 150 may each be provided in a variety of forms. For example, brackets 152 may be made longer or shorter and/or may extend at different angles (as shown in FIGS. 1, 2a, and 2b for brackets 152a and 152b).

FIGS. 6a and 6b show an example weldment 600 for carrying the rails 110 and 120 and for attaching the rails to a side of the vehicle 110 via the mounting bracket 132. Here, it can be seen that joiners 130 space apart the rail segments (110a, 110b, and 210a, 210b), connect together the rails 110 and 120, and connect both rails 110 and 120 to the mounting bracket 132. To avoid cluttering the drawing, some joiners 130 are not labeled. The mounting bracket 132 itself may be bolted or otherwise fastened to the hull (body) of the vehicle 100, or it may be welded. In an example, the mounting bracket 132 includes two portions, a lateral portion 132a and a lower portion 132b. The depicted arrangement is effective at resisting upward forces, which can be considerable. Alternatives to providing the structure 600 as a weldment include providing a machined or cast structure. Although various materials may be used, steel is particularly suitable.

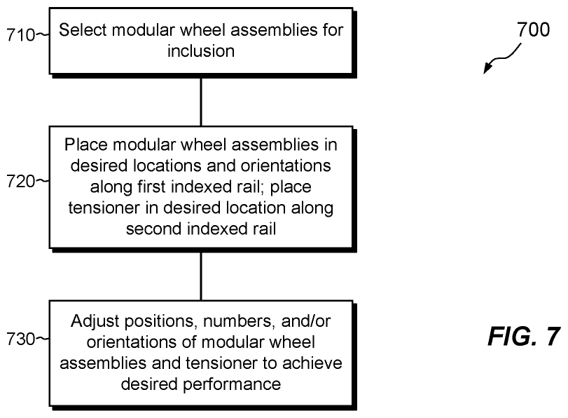

FIG. 7 shows an example method 700 that may be carried out in connection with the tracked vehicle 100. The various acts of method 700 may be ordered in any suitable way. Accordingly, embodiments may be constructed in which acts are performed in orders different from that illustrated, which may include performing some acts simultaneously.

At 710, modular wheel assemblies 150 are selected for supporting the vehicle 100. For example, a particular type or types of wheel assemblies (FIGS. 5a-5c) may be selected, in any desired number. At 720, the modular wheel assemblies 150 are placed and fastened at desired locations and orientations along the first rail 110, and the tensioner 140 is placed at a desired location along the second rail 120.

Some examples may further include step 730, where the positions, numbers, and/or orientations of modular wheel assemblies 150 and tensioner 140 are adjusted to achieve desired performance. Such adjusting may be performed manually or automatically, and may involve moving any of the wheel assemblies 150 from an initial location to a new location along a rail.

An improved technique has been described that provides a modular apparatus in which wheel assemblies 150 of a tracked vehicle 100 can be added, removed, located, and/or relocated over a range of adjustments. The apparatus includes a rail 110 or 120 attached to the tracked vehicle 100 and modular wheel assemblies 150 that can be attached to the rail at variable locations. Advantageously, the modular apparatus enables the tracked vehicle 100 to be configured in a wide variety of ways, for addressing a wide range of preferences and requirements.

Having described certain embodiments, numerous alternative embodiments or variations can be made. Further, although features have been shown and described with reference to particular embodiments hereof, such features may be included and hereby are included in any of the disclosed embodiments and their variants. Thus, it is understood that features disclosed in connection with any embodiment are included in any other embodiment.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

What is claimed is:

1. A modular apparatus for supporting wheels of a tracked vehicle, comprising:
a rail that extends lengthwise along a side of the vehicle; and
a plurality of wheel assemblies attached to the rail at a set of user-selected locations along the rail,
wherein the wheel assemblies are constructed and arranged to guide a track in a loop around the wheel assemblies on the side of the vehicle.

2. The apparatus of claim 1, wherein the rail is an indexed rail that defines discrete locations at which the plurality of wheel assembles can be attached.

3. The apparatus of claim 2, wherein the indexed rail includes a plurality of equally-spaced features that define the discrete locations.

4. The apparatus of claim 3, wherein each wheel assembly of the plurality of wheel assemblies attaches to the rail via at least two of the equally-spaced features.

5. The apparatus of claim 3, wherein the rail includes first and second spaced-apart rail segments that run parallel to each other and have equally-spaced features that are transversely aligned.

6. The apparatus of claim 3, wherein the equally-spaced features include concave regions constructed and arranged to receive convex features of the wheel assemblies.

7. The apparatus of claim 3, wherein the rail is a lower rail constructed and arranged to attach to wheel assemblies that support the track from above, and wherein the modular apparatus further comprises an upper rail constructed and arranged to attach to a wheel assembly that supports the track from below.

8. The apparatus of claim 7, wherein the wheel assembly that supports the track from below includes a track tensioner, and wherein the wheel assembly that supports the track from below is constructed and arranged to attach to the second rail at multiple locations for establishing respective degrees of track tension.

9. A tracked vehicle, comprising:
a vehicle hull;
a first rail that extends lengthwise along a first side of the vehicle hull;
a second rail that extends lengthwise along a second side of the vehicle hull;
a first plurality of wheel assemblies attached to the first rail at a set of user-selected locations along the first rail, the first plurality of wheel assemblies constructed and arranged to guide a first track in a loop around the first plurality of wheel assemblies; and
a second plurality of wheel assemblies attached to the second rail at a set of user-selected locations along the second rail, the second plurality of wheel assemblies constructed and arranged to guide a second track in a loop around the second plurality of wheel assemblies.

10. The tracked vehicle of claim 9, wherein the first rail is constructed and arranged to support the first track from above, wherein the second rail is constructed and arranged to support the second track from above, and wherein the tracked vehicle further comprises:
a first upper rail that extends lengthwise along the first side of the vehicle hull, the first upper rail configured to support the first track from below; and
a second upper rail that extends lengthwise along the second side of the vehicle hull, the second upper rail configured to support the second track from below.

11. The tracked vehicle of claim 10, wherein each of the first rail, second rail, first upper rail, and second upper rail includes a respective pair of spaced-apart rail segments.

12. The tracked vehicle of claim 11,
wherein the first rail and the first upper rail are parts of a single weldment that attaches to the first side of the vehicle hull, and
wherein the second rail and the second upper rail are parts of a single weldment that attaches to the second side of the vehicle hull.

13. A method of configuring a tracked vehicle, comprising:
providing a rail that extends lengthwise along a side of the tracked vehicle;
selecting a plurality of wheel assemblies for attaching to the rail;
selecting a set of locations along the rail at which to attach the plurality of wheel assemblies; and
attaching the plurality of wheel assemblies at the selected locations.

14. The method of claim 13, further comprising moving at least one of the plurality of wheel assemblies from an initial location along the rail to a new location along the rail.

15. The method of claim 13, wherein selecting the plurality of wheel assemblies for attaching to the rail includes selecting between a first wheel assembly having suspension and a second wheel assembly not having suspension.

16. The method of claim 13, wherein a particular wheel assembly of the plurality of wheel assemblies is configured to attach to the rail in both a forward-facing direction and a reverse-facing direction, and wherein the method further comprises selecting one of the forward-facing direction or the reverse-facing direction when attaching the particular wheel assembly to the rail.

17. The method of claim 13, wherein the rail is a lower rail, wherein the tracked vehicle includes a track that extends around the plurality of wheel assemblies, and wherein the method further comprises:
providing an upper rail that extends lengthwise along the side of the tracked vehicle above the lower rail;
providing a tensioner wheel assembly for attaching to the upper rail; and
selecting a location along the upper rail at which to attach the tensioner wheel assembly for establishing a desired tension of the track.
